(19) United States
(12) Patent Application Publication
(10) Pub. No.: US 2010/0158521 A1
(43) Pub. Date: Jun. 24, 2010

(54) OPTICAL MIXER FOR COHERENT DETECTION OF POLARIZATION-MULTIPLEXED SIGNALS

(75) Inventors: Christopher R. Doerr, Middletown, NJ (US); Peter J. Winzer, Aberdeen, NJ (US)

Correspondence Address: MENDELSOHN, DRUCKER, & ASSOCIATES, P.C., 1500 JOHN F. KENNEDY BLVD., SUITE 405, PHILADELPHIA, PA, 19102, US

(73) Assignee: ALCATEL-LUCENT USA INC., Murray Hill, NJ (US)

(21) Appl. No.: 12/338,492

(22) Filed: Dec. 18, 2008

(51) Int. Cl. H04J 14/06

(52) U.S. Cl. 398/65

(57) ABSTRACT

An optical mixer that, in one embodiment, has a single optical hybrid optically coupled to a single polarization beam splitter. The optical hybrid mixes a polarization-multiplexed optical communication signal and a local-oscillator signal to generate four mixed signals, each corresponding to a different relative phase shift between the communication and local-oscillator signals. The polarization beam splitter separates each of the mixed signals into two polarization components, subsequent processing of which enables an optical receiver employing the optical mixer to recover the data carried by the communication signal.

### CROSS-REFERENCE TO RELATED APPLICATIONS

The subject matter of this application is related to the subject matter of U.S. patent application Ser. No. 11/426,191, filed Jun. 23, 2006, published as U.S. Patent Application Publication No. 2007/0297806, which is incorporated herein by reference in its entirety.

### BACKGROUND OF THE INVENTION

1. Field of the Invention

The present invention relates to optical communication equipment and, more specifically, to an optical mixer for coherent detection of polarization-multiplexed communication signals.

2. Description of the Related Art

This section introduces aspects that may help facilitate a better understanding of the inventions). Accordingly, the statements of this section are to be read in this light and are not to be understood as admissions about what is in the prior art or what is not in the prior art.

An optical coherent-detection scheme is capable of detecting not only the amplitude of an optical signal, but also the signal's polarization and phase. These capabilities make optical coherent detection compatible with polarization multiplexing and with the use of spectrally efficient modulation formats, such as quadrature amplitude modulation (QAM) and phase-shift keying (PSK) in its various forms (e.g., differential binary PSK (DBPSK) and differential quadrature PSK (DQPSK)). Compared to incoherent detectors, optical coherent detectors offer relatively easy wavelength tunability, good rejection of interference from adjacent channels in dense wavelength-division-multiplexing (DWDM) systems, linear transformation of the electromagnetic field into an electrical signal for effective application of modem digital signal processing techniques, and an opportunity to use polarization-division multiplexing (PDM).

A polarization-sensitive optical coherent detector usually employs an optical mixer that combines a received optical communication signal and a local oscillator (LO) signal so that the data carried by the polarization components of the optical communication signal can be recovered. A representative optical mixer of the prior art includes (i) at least two optical hybrids and (ii) at least two polarization splitters. Disadvantageously, this multiplicity of constituent devices causes optical mixers of the prior art to be relatively expensive, which hinders their commercial use.

### SUMMARY OF THE INVENTION

An optical mixer is provided that, in one embodiment, has a single optical hybrid optically coupled to a single polarization beam splitter. The optical hybrid mixes a polarization-multiplexed optical communication signal and a local-oscillator (LO) signal to generate four mixed signals, each corresponding to a different relative phase shift between the polarization-multiplexed and LO signals. The polarization beam splitter is a monolithic optical element that separates each of the four mixed signals into two polarization components, subsequent processing of which enables an optical receiver employing the optical mixer to recover the data carried by the polarization-multiplexed signal.

According to one embodiment of the present invention, provided is an apparatus having: (A) an optical hybrid adapted to optically mix a polarization-multiplexed signal and an LO signal to generate a plurality of mixed signals, each corresponding to a different relative phase shift between the polarization-multiplexed signal and the LO signal; and (B) a polarization beam splitter adapted to (i) receive two or more signals of the plurality of mixed signals from the optical hybrid and (ii) separate each of the received mixed signals into a first polarization component and a second polarization component.

According to another embodiment of the present invention, provided is a method of processing a polarization-multiplexed optical signal having the steps of: (A) optically mixing the polarization-multiplexed signal and an LO signal to generate a plurality of mixed signals, each corresponding to a different relative phase shift between the polarization-multiplexed signal and the LO signal; and (B) applying two or more signals of the plurality of mixed signals to a polarization beam splitter to separate each of the applied signals into a first polarization component and a second polarization component.

### BRIEF DESCRIPTION OF THE DRAWINGS

Other aspects, features, and benefits of the present invention will become more fully apparent from the following detailed description, the appended claims, and the accompanying drawings in which:

FIG. 1 shows a block-diagram of an optical receiver that employs an optical coherent-detection scheme according to one embodiment of the invention;

FIG. 2 shows a block diagram of an optical mixer that can be used in the optical receiver of FIG. 1 according to one embodiment of the invention;

FIG. 3 shows a layout of a balanced detector array that can be used in the optical receiver of FIG. 1 according to one embodiment of the invention;

FIG. 4 shows a layout of a non-balanced detector array that can be used in the optical receiver of FIG. 1 according to another embodiment of the invention;

FIGS. 5A-C show an optical mixer that can be used in the optical receiver of FIG. 1 according to another embodiment of the invention; and

FIG. 6 shows a front view of a detector array that can be used in the optical receiver of FIG. 1 according to yet another embodiment of the invention.

### DETAILED DESCRIPTION

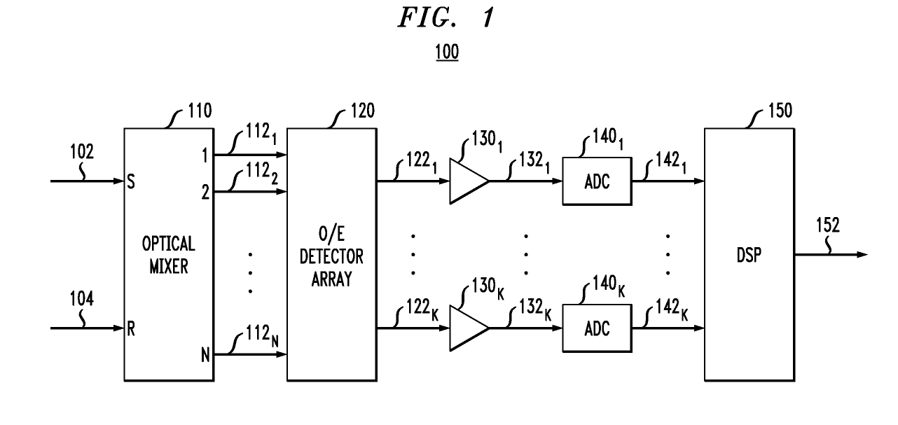

FIG. 1 shows a block-diagram of an optical receiver 100 that employs an optical coherent-detection scheme according to one embodiment of the invention. Receiver 100 has an optical mixer 110 having (i) two input ports labeled S and R and (ii) a plurality of output ports labeled 1 through N. Optical mixer 110 optically mixes input signals 102 and 104 to generate N output signals 112₁-112_{N}. Input signal 102 is a polarization-multiplexed optical communication signal having two independently modulated polarization components. Input signal 104 is a local-oscillator (LO) signal having substantially the same optical-carrier frequency (wavelength) as optical communication signal 102. In one embodiment, LO signal 104 is generated at receiver 100 using a tunable laser controlled by a wavelength-control loop (not explicitly shown in FIG. 1), which forces an output wavelength of the tunable laser to track the carrier wavelength of optical communication signal 102. In an alternative embodiment, LO signal 104 is received from a remote transmitter (not explicitly shown in FIG. 1), e.g., as disclosed in U.S. Pat. No. 7,269,356, which is incorporated herein by reference in its entirety.

Receiver 100 also has a detector array 120 that converts signals 112₁-112_{N} into K electrical signals 122 that are indicative of complex values corresponding to the independently modulated polarization components of signal 102. Each of electrical signals 122₁-122_{K} is amplified in a corresponding amplifier 130. Each of the resulting amplified signals 132₁-132_{K} is converted into digital form in a corresponding analog-to-digital converter (ADC) 140. The resulting digital signals 142₁-142_{K} are processed by a digital signal processor (DSP) 150 to recover the data carried by optical communication signal 102. The recovered data are output from receiver 100 via an output signal 152. In a representative embodiment, N=8 and K=4.

An optical communication link between the remote transmitter and receiver 100 imposes a generally uncontrolled polarization rotation onto signal 102 before this signal is applied to optical mixer 110. However, DSP 150 processes digital signals 142₁-142_{K} in a manner that substantially compensates for that polarization rotation to enable receiver 100 to fully recover two independent, polarization-multiplexed data streams carried by signal 102. A signal processing technique that can be used in DSP 150 to achieve a requisite polarization-rotation compensation is disclosed, e.g., in U.S. Patent Application Publication No. 2008/0152363, which is incorporated herein by reference in its entirety.

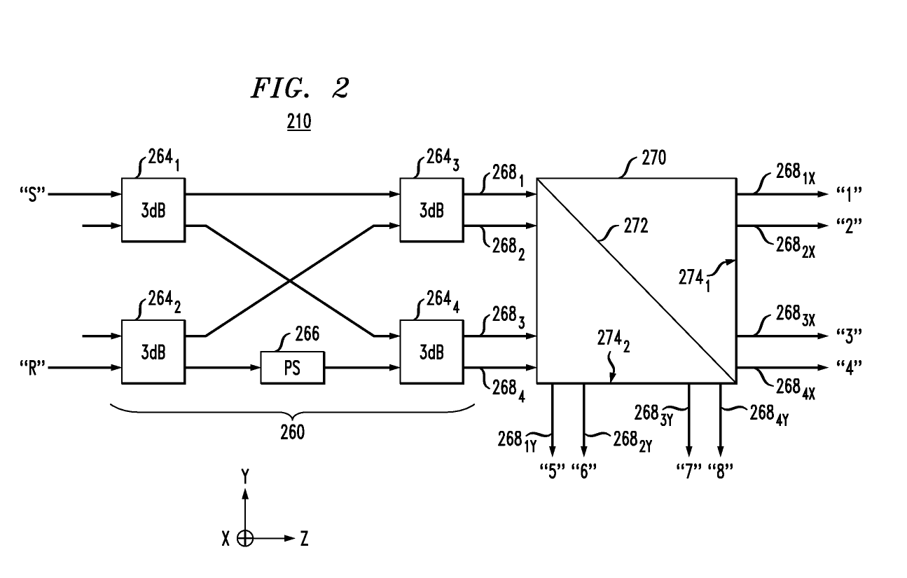

FIG. 2 shows a block diagram of an optical mixer 210 that can be used as optical mixer 110 of FIG. 1 according to one embodiment of the invention. Optical mixer 210 has an optical hybrid 260 coupled to a polarization-beam-splitter (PBS) cube 270. Because optical mixer 210 is implemented using a single optical hybrid and a single polarization beam splitter, it is advantageously less expensive than a typical, functionally comparable optical mixer of the prior art.

Optical hybrid 260 has four 3-dB couplers 264 and a phase shifter (PS) 266 interconnected as shown in FIG. 2. One input port of coupler 264₁ serves as input port S of optical mixer 210 (see also FIG. 1) while the other input port of coupler 264₁ is unutilized. Similarly, one input port of coupler 264₂ serves as input port R of optical mixer 210 while the other input port of coupler 264₂ is unutilized. Phase shifter 266 introduces an optical phase shift of about 90 degrees into a signal directed from coupler 264₂ to coupler 264₄. The four output ports of couplers 264₃ and 264₄ serve as output ports of optical hybrid 260.

PBS cube 270 has its polarization axes aligned with the X and Y axes of the coordinate system shown in FIG. 2. Each of optical signals 268₁-268₄ received by PBS cube 270 from the output ports of optical hybrid 260 is split into two polarization components corresponding to the polarization axes of the PBS cube. More specifically, a hypotenuse face 272 of PBS cube 270 transmits X-polarized components 268_{1X}-268_{4X} of signals 268₁-268₄, respectively, while reflecting Y-polarized components 268_{1Y}-268_{4Y} of those signals. As a result, an output face 274₁ of PBS cube 270 outputs X-polarized components 268_{1X}-268_{4X} Similarly, an output face 274₂ of PBS cube 270 outputs Y-polarized components 268_{1Y}-268_{4Y}. Due to the reflection imparted by hypotenuse face 272 onto Y-polarized components 268_{1Y}-268_{4Y}, the wave vectors (propagation directions) of the exiting Y-polarized components are orthogonal to the wave vectors (propagation directions) of the exiting X-polarized components 268_{1X}-268_{4X} Output faces 274₁ and 274₂ of PBS cube 270 define (as indicated in FIG. 2) output ports 1 through 4 and 5 through 8, respectively, for optical mixer 210.

The electric fields Eᵢ at the output ports of optical mixer 210 (where the subscript i=1 . . . 8 denotes the output-port number) are given by Eqs. (1a)-(1b):

$$\begin{matrix}[ \begin{matrix}{E}_{1} \\ {E}_{2} \\ {E}_{3} \\ {E}_{4}\end{matrix} ] = \frac{1}{2} [ \begin{matrix}{E}_{SX} - {E}_{RX} \\ - j {E}_{SX} - j {E}_{RX} \\ - j {E}_{SX} - j {E}_{RX} {e}^{j π / 2} \\ - {E}_{SX} + {E}_{RX} {e}^{j π / 2}\end{matrix} ] & ( 1 a ) \\ [ \begin{matrix}{E}_{5} \\ {E}_{6} \\ {E}_{7} \\ {E}_{8}\end{matrix} ] = \frac{1}{2} [ \begin{matrix}{E}_{SY} - {E}_{RY} \\ - j {E}_{SY} - j {E}_{RY} \\ - j {E}_{SY} - j {E}_{RY} {e}^{j π / 2} \\ - {E}_{SY} + {E}_{RY} {e}^{j π / 2}\end{matrix} ] & ( 1 b )\end{matrix}$$

where E_{SX} and E_{SY} are the electric fields corresponding to the X and Y polarizations, respectively, of the optical signal (e.g., optical communication signal 102 of FIG. 1) applied to input port S of the optical mixer; and E_{RX} and E_{RY} are the electric fields corresponding to the X and Y polarizations, respectively, of the optical signal (e.g., LO signal 104 of FIG. 1) applied to input port R of the optical mixer. Eqs. (1a)-(1b) show that each of signals 268₁-268₄ corresponds to a different relative phase shift between signals 102 and 104. More specifically, signals 268₁-268₄ correspond to relative phase shifts of 180, 0, 270, and 90 degrees, respectively. Optimal mixing of communication signal 102 and LO signal 104 in optical mixer 210 is achieved, e.g., when the power of the LO signal is distributed substantially evenly among mixed signals 268₁-268₄. In one configuration, this even power distribution is achieved by (i) using a linearly polarized LO signal 104 and (ii) rotating the polarization vector of the LO signal to have it oriented at about 45 degrees with respect to the X and Y axes.

One skilled in the art will appreciate that, in an alternative embodiment of optical mixer 210, PBS cube 270 can be replaced by a different suitable PBS device having a different geometric shape, e.g., a prism, a parallelepiped, or a zonohedron.

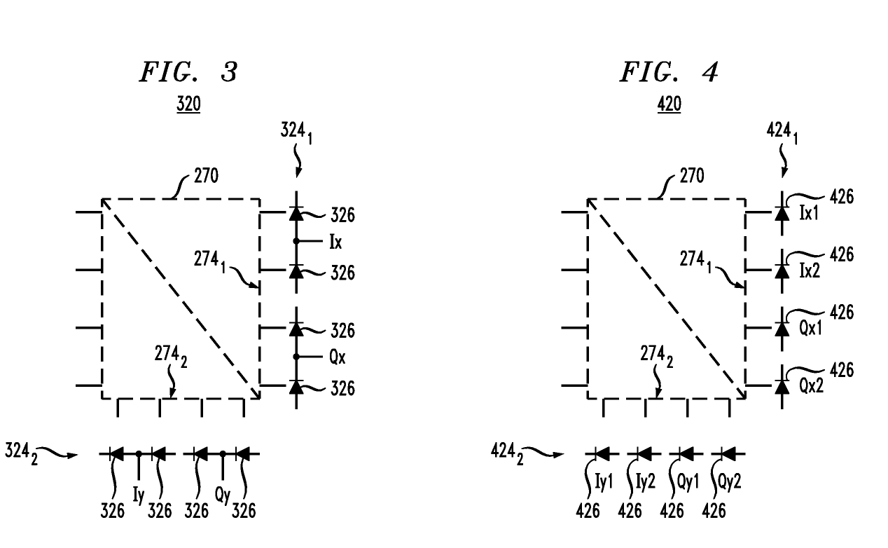

FIG. 3 shows a layout of a balanced detector array 320 that can be used as detector array 120 of FIG. 1 according to one embodiment of the invention. More specifically, detector array 320 is designed for being coupled to PBS cube 270 of optical mixer 210 (see FIG. 2). For illustration purposes, PBS cube 270 is indicated by the dashed line in FIG. 3. Detector array 320 comprises two linear sub-arrays 324₁ and 324₂, each having four photodiodes 326 that are electrically connected in pairs as shown in FIG. 3. Each electrically connected pair of photodiodes 326 forms a corresponding balanced photo-detector. Detector array 320 corresponds to an embodiment of receiver 100, in which N=8 and K=4.

In one embodiment, linear sub-arrays 324₁ and 324₂ are attached (e.g., glued) to output faces 274₁ and 274₂, respectively, of PBS cube 270, with the eight input apertures of photodiodes 326 positioned to accept output signals 268_{1X}-268_{4X} and 268_{1Y}-268_{4Y} of optical mixer 210. Photocurrents I_{X} and Q_{X} generated by the balanced photo-detectors of linear sub-array 324₁ are given by Eqs. (2)-(3):

I_{X}=A|E_{SX}∥E_{RX}| cos(Δφ) (2)

Q_{X}=A|E_{SX}∥E_{RX}| sin(Δφ) (3)

where A is the optical-to-electrical conversion efficiency of photodiode 326, and Δφ is the phase difference between the optical signals applied to input ports S and R of optical mixer 210. One skilled in the art will understand that expressions for photocurrents I_{Y} and Q_{Y} generated by the balanced photo-detectors of linear sub-array 324₂ can be obtained from Eqs. (2)-(3) by changing the Xs in the various subscripts to Ys. Based on the measured photocurrents I_{X}, Q_{X}, I_{Y}, and Q_{Y}, Eqs. (2)-(3), and their Y analogues, the values of E_{SX} E_{SY} and Δφ can be determined in a relatively straightforward manner to enable receiver 100 to fully recover the independent, polarization-multiplexed data streams carried by optical communication signal 102.

FIG. 4 shows a layout of a non-balanced detector array 420 that can be used as detector array 120 of FIG. 1 according to another embodiment of the invention. Detector array 420 is similar to detector array 320 in that it comprises two orthogonally oriented linear sub-arrays 424₁ and 424₂ and is designed for being coupled to PBS cube 270 of optical mixer 210 (see FIG. 2). However, one difference between detector array 320 and detector array 420 is that, in the latter, each photodiode 426 is used to generate a separate signal, for a total of eight signals (see signals I_{X1}, I_{X2}, Q_{X1}, Q_{X2}, I_{Y1}, I_{Y2}, Q_{Y1}, and Q_{Y2} in FIG. 4). One skilled in the art will appreciate that, similar to signals I_{X}, Q_{X}, I_{Y}, and Q_{Y} of FIG. 3, signals I_{X1}, I_{X2}, Q_{X1}, Q_{X2}, I_{Y1}, I_{Y2}, Q_{Y1}, and Q_{Y2} of FIG. 4 can be used to fully recover the data streams carried by optical communication signal 102. Detector array 420 corresponds to an embodiment of receiver 100, in which N=8 and K=8. In an alternative embodiment, the number of photo-detectors in detector array 420 can be reduced to four (K=4), e.g., by keeping in that embodiment only the detectors corresponding to I_{X1}, Q_{X1}, I_{Y1}, and Q_{Y1}, which embodiment would still enable a full data recovery under conditions, in which the power of the communication and LO signals is relatively high.

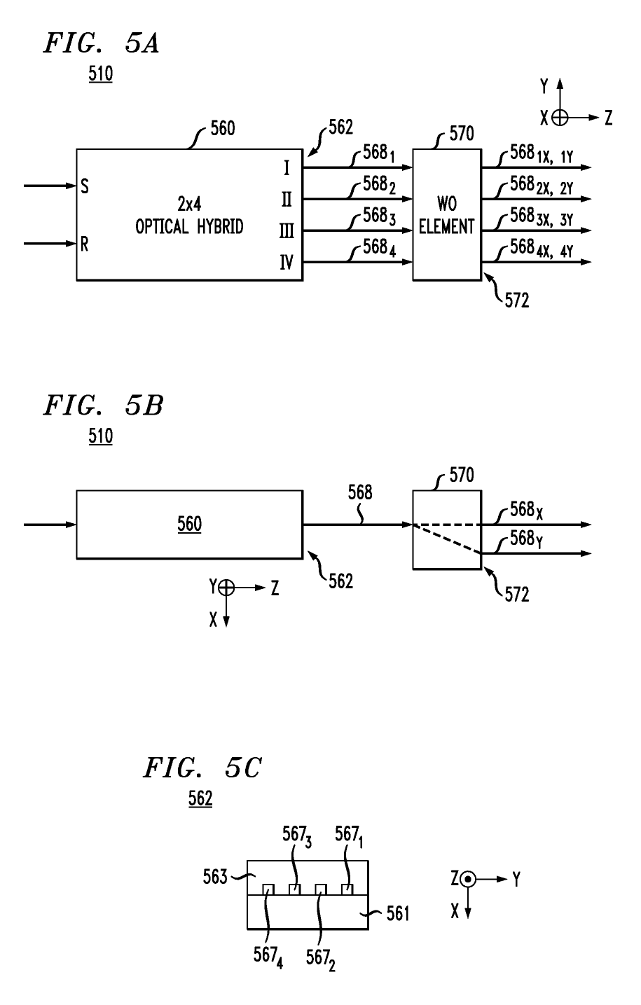

FIG. 5A-C show an optical mixer 510 that can be used as optical mixer 110 of FIG. 1 according to another embodiment of the invention. More specifically, FIGS. 5A and 5B show top and side views, respectively, of optical mixer 510. FIG. 5C shows a front view of an output face 562 of a 2×4 optical hybrid 560 used in optical mixer 510.

2×4 optical hybrid 560 is part of a planar waveguide circuit formed on a substrate 561, which defines a base plane of the circuit. In FIG. 5, the base plane of optical hybrid 560 is parallel to the YZ-coordinate plane. Similar to optical hybrid 260 (FIG. 2), optical hybrid 560 has two input ports S and R and four output ports I-IV. FIG. 5C shows the end termini of waveguides 567₁-567₄ that define output ports I-IV, respectively, of optical hybrid 560 at output face 562. The cores of waveguides 567₁-567₄ are formed on substrate 561 and covered by a cladding layer 563. Note that, at output face 562, output ports I-IV form a linear array of co-directional output ports. Optical output signals 568₁-568₄ that exit output ports I-IV all propagate parallel to the Z axis and, in terms of their relationship to the input signals, are generally analogous to optical signals 268₁-268₄ of optical hybrid 260 (see Eqs. (1a)-(1b)). In one embodiment, optical hybrid 560 is a 90° Optical Hybrid, which is commercially available from Optoplex Corporation of Fremont, Calif. In another embodiment, optical hybrid 560 is a Model CL-QOH-90 Quadrature Optical Hybrid, which is commercially available from CeLight, Inc., of Silver Spring, Md.

Optical signals 568₁-568₄ are applied to a walk-off (WO) element 570. In one embodiment, WO element 570 is a birefringent crystal having its crystal axes oriented so that the X- and Y-polarized components of each signal 568 become spatially separated in the birefringent crystal as shown in FIG. 5B. More specifically, the X-polarized component of signal 568 propagates through WO element 570 and exits from an output face 572 without a vertical (i.e., an X-) offset. In contrast, the Y-polarized component of signal 568 is refracted in WO element 570 and walks off along the X axis, thereby creating a vertical offset between the two polarizations at output face 572. Note that the offset accrues along a direction that is orthogonal to the base plane of optical hybrid 560. The exit locations of X-polarized components 568_{1X}-568_{4X} and Y-polarized components 568_{1Y}-568_{4Y} of signals 568₁-568₄, respectively, on output face 572 define eight output ports for optical mixer 510. In one embodiment, WO element 570 is one of the polarization beam splitters disclosed in U.S. Pat. No. 6,014,256, which is incorporated herein by reference in its entirety.

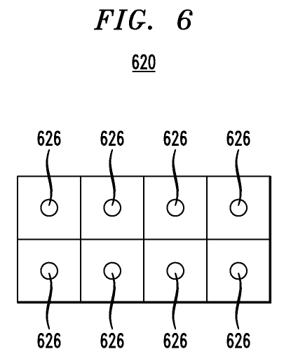

FIG. 6 shows a front view of a detector array 620 that can be used as detector array 120 of FIG. 1 according to yet another embodiment of the invention. More specifically, detector array 620 is designed for being coupled to WO element 570 of optical mixer 510 (see FIG. 5). Detector array 620 is a rectangular array (having eight photodiodes 626 arranged in two rows and four columns) that can be attached to output face 572 of WO element 570. In one embodiment, photodiodes 626 can be connected in pairs to form four balanced photo-detectors similar to those of detector array 320 (FIG. 3). In an alternative embodiment, each photodiode 626 can be used to generate a separate signal, for a total of eight signals similar to signals I_{X1}, I_{X2}, Q_{X1}, Q_{X2}, I_{Y1}, I_{Y2}, Q_{Y1}, and Q_{Y2} of FIG. 4. In another alternative embodiment, detector array 620 can have four photodiodes arranged in two rows and two columns, with those photodiodes placed to receive signals I_{X1}, Q_{X1}, I_{Y1}, and Q_{Y1} as described above in reference to detector array 420.

While this invention has been described with reference to illustrative embodiments, this description is not intended to be construed in a limiting sense. Although embodiments of the inventions have been described in reference to polarization-multiplexed signals using linearly polarized polarization components, various embodiments of the invention can also be used to process any suitable polarization-multiplexed signals, e.g., those using (i) left and right circular polarizations and (ii) transverse electric and transverse magnetic waveguide modes. Various embodiments of detector array 120 can have the values of K that range between four and eight. In certain embodiments of the invention, optical hybrid 260 or 560 can be replaced with an optical hybrid having two, instead of four, output ports. Alternatively, fewer than four output signals produced by optical hybrid 260 or 560 can be used for further processing. Various modifications of the described embodiments, as well as other embodiments of the invention, which are apparent to persons skilled in the art to which the invention pertains are deemed to lie within the principle and scope of the invention as expressed in the following claims.

As used in the claims, the term “polarization beam splitter” should be interpreted as encompassing any suitable optical device that imparts directional and/or spatial separation onto polarization components of an optical signal. In one embodiment, such a polarization beam splitter can be a monolithic optical element (e.g., an optical element cast as a single piece and/or constituting a single unit) whose input face receives four optical signals from a corresponding optical hybrid and whose output face outputs at least four polarization components corresponding to the received signals. For example, in optical mixer 210, PBS cube 270 is a monolithic optical element whose input face receives four optical signals 268₁-268₄ from optical hybrid 260 and whose output faces 274₁ and 274₂ output four polarization components each, i.e., polarization components 268_{1X}-268_{4X} and 268_{1Y}-268_{4Y}, respectively. Similarly, in optical mixer 510, WO element 570 is a monolithic optical element whose input face receives four optical signals 568₁-568₄ from optical hybrid 560 and whose output face 572 outputs eight polarization components 568_{1X}-568_{4X}/568_{1Y}-568_{4Y}.

In an alternative embodiment, such a polarization beam splitter can be a composite optical element comprising two or more monolithic polarization beam splitters (e.g., analogous to PBS cube 270 or WO crystal 570), with at least one of those monolithic polarization beam splitters receiving more than one optical signal (e.g., signals 568₁-568₂) from a corresponding optical hybrid and/or having an output face (e.g., output face 572) that outputs more than two polarization components (e.g., components 568_{1X}-568_{2X} and 568_{1Y}-568_{2Y}) corresponding to the received signals. For example, in optical mixer 210, PBS cube 270 can be replaced by two separate PBS cubes. The input face of the first PBS cube would receive two optical signals 268₁-268₂ from optical hybrid 260, and the two orthogonal output faces of that PBS cube would output two polarization components each, i.e., polarization components 268_{1X}-268_{2X} and 268_{1Y}-268_{2Y}, respectively. Similarly, the input face of the second PBS cube would receive two optical signals 268₃-268₄ from optical hybrid 260, and the two orthogonal output faces of that PBS cube would output two polarization components each, i.e., polarization components 268_{3X}-268_{4X} and 268_{3Y}-268_{4Y}, respectively. In optical mixer 510, WO element 570 can be replaced by two separate WO elements. The input face of the first WO element would receive two optical signals 568₁-568₂ from optical hybrid 560, and the output face of that WO element would output four polarization components 568_{1X}-568_{2X}/568_{1Y}-568_{2Y}. Similarly, the input face of the second WO element would receive two optical signals 568₃-568₄ from optical hybrid 560, and the output face of that WO element would output four polarization components 568_{3X}-568_{4X}/568_{3Y}-568_{4Y}.

The present invention may be implemented using free space optics and/or waveguide circuits, including possible implementation on a single integrated circuit or package.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Throughout the detailed description, the drawings, which are not to scale, are illustrative only and are used in order to explain, rather than limit the invention. The use of terms such as height, length, width, top, bottom, is strictly to facilitate the description of the invention and is not intended to limit the invention to a specific orientation. For example, height does not imply only a vertical rise limitation, but is used to identify one of the three dimensions of a three dimensional structure as shown in the figures. Such “height” would be vertical where the electrodes are horizontal but would be horizontal where the electrodes are vertical, and so on. Similarly, while all figures show the different layers as horizontal layers such orientation is for descriptive purpose only and not to be construed as a limitation.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

What is claimed is:

1. Apparatus, comprising:
an optical hybrid adapted to optically mix a polarization-multiplexed signal and a local-oscillator (LO) signal to generate a plurality of mixed signals, each corresponding to a different relative phase shift between the polarization-multiplexed signal and the LO signal; and
a polarization beam splitter adapted to (i) receive two or more signals of the plurality of mixed signals from the optical hybrid and (ii) separate each of the received mixed signals into a first polarization component and a second polarization component.

2. The invention of claim 1, wherein the apparatus is an optical receiver adapted to recover data carried by the polarization-multiplexed signal.

3. The invention of claim 1, wherein the polarization beam splitter is a monolithic optical element.

4. The invention of claim 3, wherein:
the polarization beam splitter is a PBS cube having an input face that receives four mixed signals from the optical hybrid;
the PBS cube has a first output face that outputs the first polarization components; and
the PBS cube has a second output face that outputs the second polarization components.

5. The invention of claim 3, wherein the polarization beam splitter is an optical walk-off element having:
an input face that receives four mixed signals from the optical hybrid; and
an output face that outputs the first and second polarization components so that each polarization component is spatially separated from other polarization components.

6. The invention of claim 5, further comprising a rectangular array of photo-detectors attached to the output face, wherein each photo-detector receives a corresponding one of the polarization components.

7. The invention of claim 1, wherein the polarization beam splitter separates the received mixed signals so that:
the first polarization components propagate parallel to a first direction; and
the second polarization components propagate parallel to a different second direction.

8. The invention of claim 7, wherein:
the polarization beam splitter is a PBS cube; and
the second direction is orthogonal to the first direction.

9. The invention of claim 1, wherein:
the optical hybrid is implemented as a planar waveguide circuit having a base plane; and
the polarization beam splitter separates the received mixed signals so that:
wave vectors of the first polarization components lie in a first plane that is parallel to the base plane; and
wave vectors of the second polarization components lie in a second plane that is parallel to the base plane and offset with respect to the first plane.

10. The invention of claim 9, wherein the polarization beam splitter is an optical walk-off element.

11. The invention of claim 1, wherein, when the LO signal is a linearly polarized signal whose polarization vector is oriented at about 45 degrees with respect to a polarization axis of the polarization beam splitter, the optical hybrid optimally mixes the polarization-multiplexed signal and the LO signal.

12. The invention of claim 1, further comprising:
a detector array optically coupled to the polarization beam splitter and adapted to convert the polarization components into a plurality of electrical signals;
an analog-to-digital converter adapted to convert the plurality of electrical signals into a corresponding plurality of digital signals; and
a digital signal processor adapted to process said plurality of digital signals to recover data carried by the polarization-multiplexed signal.

13. A method of processing a polarization-multiplexed optical signal, comprising:
optically mixing the polarization-multiplexed signal and a local-oscillator (LO) signal to generate a plurality of mixed signals, each corresponding to a different relative phase shift between the polarization-multiplexed signal and the LO signal; and
applying two or more signals of the plurality of mixed signals to a polarization beam splitter to separate each of the applied signals into a first polarization component and a second polarization component.

14. The invention of claim 13, further comprising processing the first and second polarization components to recover data carried by the polarization-multiplexed signal.

15. The invention of claim 13, wherein the polarization beam splitter is a monolithic optical element.

16. The invention of claim 15, wherein:
the polarization beam splitter is a PBS cube having an input face to which four mixed signals are applied; and
the PBS cube has:
a first output face that outputs the first polarization components; and
a second output face that outputs the second polarization components.

17. The invention of claim 15, wherein the polarization beam splitter is an optical walk-off element having:
an input face to which four mixed signals are applied; and
an output face that outputs the first and second polarization components so that each polarization component is spatially separated from other polarization components.

18. The invention of claim 13, wherein the polarization beam splitter separates the applied signals so that:
the first polarization components propagate parallel to a first direction; and
the second polarization components propagate parallel to a different second direction.

19. The invention of claim 13, wherein:
wave vectors of the applied signals lie in a base plane; and
the polarization beam splitter separates the received mixed signals so that:
wave vectors of the first polarization components lie in a first plane that is parallel to the base plane; and
wave vectors of the second polarization components lie in a second plane that is parallel to the base plane and offset with respect to the first plane.

20. The invention of claim 13, wherein:
the LO signal is a linearly polarized signal; and
the method further comprises rotating a polarization vector of the LO signal vector to have said vector oriented at about 45 degrees with respect to a polarization axis of the polarization beam splitter.
